(19) United States
(12) Patent Application Publication
(10) Pub. No.: US 2023/0335003 A1
(43) Pub. Date: Oct. 19, 2023

(54) METHOD AND SYSTEM FOR NEUROSCIENTIFIC READING TRAINING

(71) Applicants: JoAnne Leff, New York, NY (US); Jerrold Blum, Bloomfield, CT (US)

(72) Inventors: JoAnne Leff, New York, NY (US); Jerrold Blum, Bloomfield, CT (US)

(21) Appl. No.: 18/144,521

(22) Filed: May 8, 2023

Related U.S. Application Data
(60) Provisional application No. 63/475,988, filed on Jan. 5, 2023.

(51) Int. Cl. G09B 17/00; G06F 3/04817; G06F 3/16; G09B 17/04; G09B 5/06

(52) U.S. Cl. CPC G09B 17/003; G06F 3/04817; G06F 3/167; G09B 5/06; G09B 17/04

(57) ABSTRACT

A neuroscientific method to train optimized reading skills proficiency customized to the needs of each participating student is disclosed. The novel training method causes a creation of optimized specific to task neural pathways and reinforcement of these optimized neural pathways through repetition of the neuroscientific method.

This patent relates back to US 63/475,988 filed on Jan. 5, 2023, and is incorporated in its entirety.

### BACKGROUND

### Technical Field

The present disclosure relates, in general, to the application of necessary neuroscientific elements to create a customized and optimized reading skills training proficiency method for both adults and school children.

Reading skills are fundamental to a professional as well as personal success in life. Further, the inability to read effectively creates not only individual, but societal problems that need not occur if reading skills were effectively trained across our country, but it is widely known that reading scores of students in any school setting in the United States alone have become horrifically lower and lower with not even a hint of a true solution underway. The American journalist and political commentator who authored two New York Times best sellers, Mona Charen, stated on NBC News in late March of 2023 that “there exists a major problem in American schools with only 35% of 4th grade students able to read at grade level.” On January 20 of 2023, Charen stated in print that “Even before the dramatic learning loss caused by COVID, only one third of American 4th and 8th graders were reading at grade level. How is that not a massive scandal?”

According to a Gallup analysis of data from the U.S. Department of Education, there are about 130 million adults in the U.S. who have low literacy skills. This indicates that 54% of Americans between the ages of 16 and 74 read at a level below that of the sixth grade. Recently it was reported that California spent $136 billion last year on public schools. Yet, it was further reported that more than half of California’s students are reading below grade level.

There are those that blame the pandemic, but that’s merely a political tactic, as is understood by most. As stated in The Hechinger Report, 2021: “Even before the pandemic, nearly two-thirds of U.S. students were unable to read at grade level. Scores had been getting worse for several years. The pandemic made a bad situation worse.”

On May 2, 2008, long before the pandemic, $6 billion was ill spent on a horribly unsuccessful Reading Program (“Reading First”) that improved nothing in terms of reading scores. As per The Associated Press, WASHINGTON - “From the beginning, President Bush’s Reading First program has had problems - charges of conflicts of interest, bruising budget fights. Perhaps the worst of all: The Education Department says it doesn’t work any better than approaches already in place. Democrats called yesterday for a new look at the $6 billion reading program after a federal study showed it had no special impact on reading comprehension. The program was at the heart of Mr. Bush’s signature education law, No Child Left Behind. But, there was no difference in comprehension scores between students who participated in Reading First and those who did not, says the new study from the Institute of Education Sciences.” Published Oct. 24, 2022 1:59pm EDT: Jeb Bush says plunging US math, reading scores should be ‘call to arms.’ Jeb Bush went on to say, “We should put aside the hyper-partisanship that dominates life in Washington and realize that this really is important, that kids learn how to read and learn how to calculate math in a way that allows them to live a life of purpose and meaning. And right now, that is at risk.” “And we spend more on education than any other country besides Belgium,” Bush said.

Now, with no solid answers, the authorities in the field are refocusing on phonics as a means to effectively teach reading and to raise reading scores, while Neuroscience research has shown that skilled readers process all of the letters in words when they read them, and that they read connected text very quickly. But this goes unnoticed. What is clearly and sorely needed is a reading skills training program that is based on neuroscientific principles and simply creates reading skills proficiency as quickly and efficiently as possible. And there is a solution - the method and system for neuroscientific reading training presented herein.

Current teaching methodologies tend to focus on traditional, yet ineffective and unduly complex “didactic” teaching of reading skills. However, this model of teaching often leads to bored, inattentive students, who are unable to read at their grade level, the statistics of which has been documented numerous times in so many US cities, and who may very well be stalled in their ability to read without various problems for their lifetime. These students, educators, policy makers, and even top academic scientists who take deep dives into the minutia of their particular field, don’t often make broad connections with other fields and therefore, have not made the connection, albeit holding deep importance, between the neuroscientific creation of neural pathways autonomically made in the brain that can be created specific to task for reading skills and reinforced with repetition of usage; in fact the creation of optimized neural pathways per task and, as a result, these neural pathways along with their reading tasks become faster, deeper and more effective with repetition.

The didactic teaching that is pervasive in the US is not autonomic, and has failed decade after decade.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### SUMMARY

A neuroscientific method to train optimized reading skills proficiency customized to the needs of each participating student is disclosed. The disclosed training method and system uniquely combines and, in doing so, applies the necessary specific neuroscientific elements to the field of reading skills training. This unique combination of neuroscientific elements applied to reading training automatically creates optimized reading skills proficiency for each participating student through simple interactive actions. These actions cause the creation of optimized neural pathways in the brain and their reinforcement of the optimized neural pathways through repetition of this neuroscientific method. This neuroscientific reading training method and system uniquely creates this automatic, autonomic neuroscientific process which necessarily creates reading skills proficiency for each participating student as opposed to the teacher-led “didactic” and unnecessarily complex transfer of bits of information, as with phonics, which is prevalent across our country to its detriment.

In an aspect of the disclosure, a neuroscientific method to train optimized reading skills proficiency customized to the needs of each participating student presenting on a display a plurality of words revealed incrementally, includes selecting a capability level customized for each participating student for either a part or all of a training session or at any time during an entire training in this aspect of the disclosure; selecting a word speed customized for each student, where the word speed is decided upon by a words per minute meter, where the word speed is modifiable at any time; presenting on a display a plurality of words revealed incrementally through a first moving graphical encasement that proceeds from a far left side of the display to a far right side of the display, where the plurality of words comprises a fully justified line of words to be utilized for training by each student, and where the first moving graphical encasement reveals a beginning portion of the plurality of words and then progressively more words as the first moving graphical encasement proceeds across the display; removing automatically the first moving graphical encasement from the far right side of the display when the plurality of words seen within the first moving graphical encasement ends; upon removing the first moving graphical encasement from the display, immediately and automatically issuing an audible sound to indicate that the full line of words is completed, which is a positive form of operant conditioning for the student, since it signals that they have completed a full line of words; and presenting immediately and automatically thereafter on the display a second and different moving graphical encasement emerging from the far left, different from the first moving graphical encasement to indicate a new line of words has begun and seen through the second moving graphical encasement, the second moving graphical encasement appearing on the far left side of the display and proceeding to the far right side of the display, where the neuroscientific method results in a major part of synthesized comprehension for each student and creates an optimized fluency for each student with repetition.

In another aspect of the disclosure, a neuroscientific method to train optimized reading skills proficiency customized to the needs of each participating student using a tachistoscopic flashing of words causing the creation of optimized neural pathways and reinforcement of the optimized neural pathways through a repetition of the neuroscientific method is disclosed. This tachistoscopic training includes selecting a capability level customized for each participating student for either a part or all of the tachistoscopic training or at any time during an entire training; providing a flash selection icon on a display for the student to select; waiting a predetermined delay to create added focus, anticipation and productive stress (which allows for the neuroplasticity of the brain) before a first word is to be flashed; tachistoscopically flashing the first word, where the first word is displayed in a graphical encasement around the first word, where the tachistoscopic flashing of the first word results in an optimized increase of short term memory and long term memory, a speed of memory recovery, an increase to the student’s optimal levels of spelling, vocabulary, pronunciation, span of recognition, focus, concentration, operant conditioning and visualization capabilities; simultaneously with tachistoscopically flashing the first word, pronouncing the first word by an audio-produced voice; immediately prompting the student to pronounce the first word as just heard by the audio-produced voice simultaneously with a visual of the tachistoscopically flashing of the word to note a spelling of the first word, and to then input the first word into a designated region of the display where the first word was flashed; receiving from the student an input of the first word from the designated region of the display; prompting the student to select a spelling check icon on the display; responsive to the input of the first word being correct, displaying an encouragement message on the display and displaying an icon for the student to select to proceed, where upon selecting the icon to proceed, introducing a second word displayed within a second different graphical encasement and displaying the flash icon to proceed to engage the flash icon; and responsive to the input of the first word being incorrect, displaying an encouragement (e.g., “Let’s Try Again!”) message on the display and displaying an icon for the student to select to proceed, where upon selecting the icon to proceed, displaying the flash icon to proceed with the first word displayed again and within the same first graphical encasement, where if the first word is incorrectly input into the designated region of the display three times in a row, introducing the second word.

The foregoing summary is illustrative only and is not intended to be in any way limiting. In addition to the illustrative aspects, aspects, and features described above, further aspects, aspects, and features will become apparent by reference to the drawings and the following detailed description.

Other systems, methods, features, and advantages of the disclosure will be, or will become, apparent to one with skill in the art upon examination of the following figures and detailed description. It is intended that all such additional systems, methods, features and advantages be included within this description, be within the scope of the disclosure, and be protected by the following claims.

### BRIEF DESCRIPTION OF THE DRAWINGS

The disclosure can be better understood with reference to the following drawings and description of an aspect. The elements in the figures are not necessarily to scale, emphasis instead being placed upon illustrating the principles of an aspect of the disclosure. Moreover, in the figures, like referenced numerals designate corresponding parts throughout the different views of the aspect.

FIG. 1 shows a word level selection menu, according to an aspect of the disclosure.

FIG. 2 shows a word level selection interface, according to an aspect of the disclosure.

FIG. 3 shows an example display of the setting for a plurality of words revealed incrementally, according to an aspect of the disclosure.

FIG. 4 shows an example display of the beginning of a plurality of words revealed incrementally through the beginnings of a first moving graphical encasement, according to an aspect of the disclosure.

FIG. 5 shows an example display of a plurality of words revealed incrementally, according to an aspect of the disclosure.

FIG. 6 shows an example display of a plurality of words revealed incrementally as the first moving graphical encasement and the words seen through it approaches the end of the line, according to an aspect of the disclosure.

FIG. 7 shows an example display of the beginning of a plurality of words revealed incrementally through the beginnings of a second moving graphical encasement, according to an aspect of the disclosure.

FIG. 8 shows an example display of the end of a plurality of words revealed incrementally, according to an aspect of the disclosure.

FIG. 9 shows an example display of encouragement at the completion of a day of a plurality of words revealed incrementally, according to an aspect of the disclosure.

FIG. 10 shows an example display of the graphical encasement within which the tachistoscopic flashing of a word has a designated space to be displayed, according to an aspect of the disclosure.

FIG. 11 shows an example display of the graphical encasement within which the tachistoscopic flashing of a word is displayed, according to an aspect of the disclosure.

FIG. 12 shows an example display of directions being given to student, “Say, Then Type The Word!”, according to an aspect of the disclosure.

FIG. 13 shows an example display of the word having been typed, according to an aspect of the disclosure.

FIG. 14 shows an example display of an encouragement response, “Correct - YAY! Go to Next Word!” to the student, given they pronounced and typed the word in its designated space correctly, according to an aspect of the disclosure.

FIG. 15 shows an example display of the new graphical encasement within which the tachistoscopic flashing of a new word is displayed after the “Correct - YAY! Go to Next Word!” is displayed in FIG. 13, according to an aspect of the disclosure.

FIG. 16 shows an example display of the graphical encasement when a new word is tachistoscopically flashed, according to an aspect of the disclosure.

FIG. 17 shows an example display of directions being given to student, “Say, Then Type The Word!”, according to an aspect of the disclosure.

FIG. 18 shows an example display of the word having been incorrectly typed, according to an aspect of the disclosure.

FIG. 19 shows an example display of an encouragement response, though incorrect, “Incorrect - Let’s Try Again!” to the student, given they pronounced and typed the word in its designated space incorrectly, according to an aspect of the disclosure.

FIG. 20 shows an example display of the graphical encasement within which the tachistoscopic flashing of the prior incorrectly input word has a designated space to be displayed, according to an aspect of the disclosure.

FIG. 21 shows an example display of directions being given to student, “Say, Then Type The Word!” for the prior incorrectly input word, according to an aspect of the disclosure.

FIG. 22 shows an example display of the word having been correctly typed, according to an aspect of the disclosure.

FIG. 23 shows an example display of an encouragement response, “Correct - YAY! Go to Next Word!” to the student, given they pronounced and typed the word in its designated space correctly, according to an aspect of the disclosure.

FIG. 24 shows an example display of a new graphical encasement within which the tachistoscopic flashing of a new word will be displayed after the “Correct - YAY! Go to Next Word!” is displayed in FIG. 22, according to an aspect of the disclosure.

FIG. 25 shows an example display when the Flash Words process is completed along with the whole day’s training program for the day, according to an aspect of the disclosure.

FIG. 26 shows example acts in a process for a plurality of words that are revealed incrementally in the paced reading process, according to an aspect of the disclosure.

FIG. 27 shows example acts in a process for tachistoscopically flashing words, according to an aspect of the disclosure.

### DETAILED DESCRIPTION

Some aspects of the present disclosure will now be described more fully hereinafter with reference to the accompanying drawings, in which some, but not all, aspects are shown. Indeed, various aspects may be embodied in many different forms and should not be construed as limited to the aspects set forth herein; rather, these aspects are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with aspects of the present disclosure. Thus, use of any such terms should not be taken to limit the spirit and scope of aspects of the present disclosure.

The elements in the Figures interoperate as explained in more detail below. Before setting forth the detail explanation, however, it is noted that all of the discussion below, regardless of the particular implementation being described, is exemplary in nature, rather than limiting. For example, although selected aspects and their features or processes of the implementations are depicted as being stored in memories, all or part of systems and methods consistent with the display systems may be stored on, distributed across, or read from other machine-readable media, for example, secondary storage devices such as hard disks, floppy disks, and CD-ROMs; a signal received from a network; or other forms of ROM or RAM either currently known or later developed.

Furthermore, although specific elements of the architecture of an example aspect will be described, methods, systems, and articles of manufacture consistent with the architecture may include additional or different elements. For example, a processor may be implemented as a microprocessor, microcontroller, application specific integrated circuit (ASIC), discrete logic, or a combination of other type of circuits or logic. Similarly, memories may be DRAM, SRAM, Flash, or any other type of memory. Flags, data, databases, tables, and other data structures may be separately stored and managed, may be incorporated into a single memory or database, may be distributed, or may be logically and physically organized in many different ways. Method and systems described herein may be parts of a single method and system, separate methods and systems, or distributed across several memories and processors.

In the following description, numerous specific details are set forth to clearly describe various specific aspects disclosed herein. One skilled in the art, however, will understand that the presently claimed disclosure may be practiced without all of the specific details discussed below. In other instances, well-known features have not been described so as not to obscure the disclosure. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings. In addition, it should be understood that aspects of the disclosure include both hardware and electronic components or modules that, for purposes of discussion, may be illustrated and described as if the majority of the components were implemented solely in hardware. However, one of ordinary skill in the art, and based on a reading of this detailed description, would recognize that, in at least one aspect, the electronic based aspects of the disclosure may be implemented in software. As such, it should be noted that a plurality of hardware and software-based devices, as well as a plurality of different structural components may be utilized to implement the disclosure. Furthermore, and as described in subsequent paragraphs, the specific logical software configurations illustrated in the drawings are intended to exemplify aspects of the disclosure and that other alternative configurations are possible.

Moreover, acts and steps taken in a process disclosed herein may be different or performed with more or fewer acts or steps taken to execute the process and the acts and steps illustrated herein are not necessarily in a specific order. Acts and process steps taken may be in different order as known to one of skill in the art.

The following briefly describes the aspects of the disclosure. This brief description is not intended as an extensive overview. It is not intended to identify key or critical elements, or to delineate or otherwise narrow the scope. Its purpose is merely to present some concepts in a simplified form as a prelude to the more detailed description that is presented later. It will be understood by one of ordinary skill in the art that the disclosed aspects and implementations presented herein are exemplary aspects of the disclosed novel neuroscientific reading training method and system. Other aspects and modifications of the disclosed novel neuroscientific reading training method and system may be accomplished without deviating from the scope of the disclosures and its novel inventive concepts.

The disclosed uniquely effective, customized neuroscientific reading training method and system offers both children and adults the priceless gift of reading-simply, quickly, and with enjoyment. The disclosed neuroscientific method accomplishes this by a neuroscientific reading training method and system for each student’s optimized reading skills proficiency. Neuroscientists understand that reading difficulties are the result of insufficient neural pathways in the brain (i.e., a lack of the optimum neural pathways created and reinforced). However, the disclosed neuroscientific reading training method and system creates these optimum neural pathways as well as reinforcing them, as compared to the usual didactic teaching of reading in schools. School teachings are not neuroscientific, but rather are “didactic” in nature, adding unnecessary teacher-based communications and their biases that create more time, effort, confusion, and the creation of non-productive or counterproductive neural pathways.

The disclosed neuroscientific training system and method may provide improved results for each student from the first training session with optimum results after 3 months or less, in an aspect of the disclosure.

The features of this neuroscientific reading training method and system are unique compared to conventional teaching method and systems known in the art.

The disclosed neuroscientific reading training method and system has customized features and is comprehensive for reading skills proficiency for students of any age. The disclosed method and system can be created to take any form for interaction with a student through a screen and any form of a keyboard or input device, tactile, verbal or aural, whether separated or made as a unit.

Neural pathways in the brain are specifically and optimally created by this method and system, which, with repetition, adds speed and efficacy to the neural fiber conduction within these neural pathways, the myelin sheath covers of which are made thicker and stronger making signal transmission along these neural fibers more efficient, while proficiency in each reading skill develops more and more through repetition, which is the repetition of the neural activity created by working this method and system as well as reading on the students’ own as they feel better and better about reading as a result of this method and system.

These pathways also allow for new, additional pathways within the brain to communicate with each other--even different parts of the brain that prior have not communicated with each other but may now connect.

Therefore, the disclosed neuroscientific training method and system for optimizing each student’s reading skills proficiency provides an efficient and enjoyable system to address the country’s reading and educational scores and knowledge shortfalls of recent years.

A neuroscientific reading training method and system are disclosed herein. The disclosed neuroscientific reading training method and system expands upon and provides a concrete application of known neuroscientific elements, specifically incorporating and embodying five major aspects of neuroscientific training methods’ elements and their outcomes applied to reading training, described below in the method and system:

1) Directionality of Reading - the disclosed method and system develops complete left to right “directionality” and the immediate return to the far left to begin the next line of words to be read with fully achieved, optimized directionality through a unique and exciting manner of presenting words seen through moving “encasements” as an exemplary aspect. This process creates synthesized comprehension due to the synthesis of all five necessary neuroscientific elements named herein of this method and system, which also creates optimized fluency for each student. The method also adds focus and concentration, while reinforcing central vision and inhibiting regressions (unwanted right to left movements).

2) Span of Recognition - the disclosed method and system increases each student’s “span of recognition,” which is the number of words the student can see before an instantaneous pause (a “fixation,” which is unconsciously created and ideally one to two and a half words per such a fixation; poor readers can have only a small span of recognition-for example, seeing only a third of a word with 3 pauses/fixations for that word).

3) Addition of “Good Challenge Stress” - neuroscientifically, it is understood that some stress is necessary to create new brain cells and new neural pathways in the brain. Among other examples of “good challenge stress” used in the disclosed method and system, being able to pronounce 85% (most) of the words, as opposed to all the words, creates “good challenge stress,” which optimizes reading development.

4) Operant Conditioning - among other examples of “operant conditioning” used in the disclosed method and system, by adding an audible signal - an auditory “beep” for example, the neuroscientific method creates a positive or a negative response from the student, with the beep signaling to the student that they have completed the full line, which makes the beep sound a positive form of what neuroscientists know as a form of “operant conditioning” in this case.

5) Only the use of whole words, not pieces of words - “phonics.” Neuroscientists understand that the brain processes complete words faster and more efficiently than phonetic pieces of words, which only complicates the reading training process, and all too often created counterproductive neural pathways and their connections.

All of these neuroscientific processes are brought out in the disclosed neuroscientific training method and system. For illustration, but not to limit or exclude other emanations of the teachings of the disclosure, an exemplary aspect of the disclosure is presented in conjunction with the Figures to demonstrate one aspect of the method and system, while allowing for other implementations to accomplish the intended results (i.e., optimized reading skills for each particular student through neuroscience-based techniques) without deviating from the scope of the disclosure.

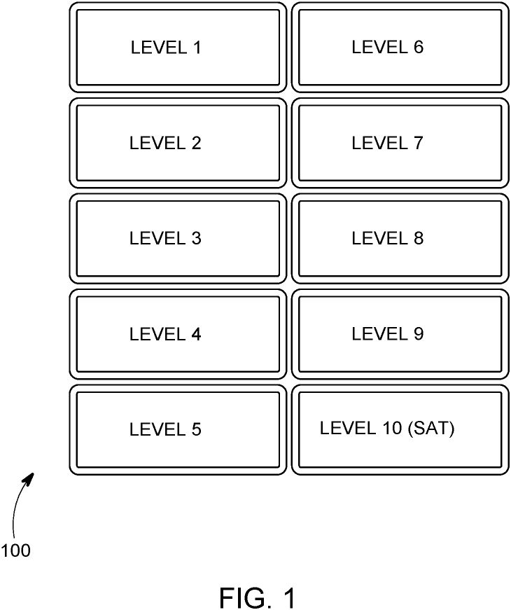

FIG. 1 shows a listing of Levels 100 available to choose based on reading level. Students choose the “LEVEL” 100 at which they will work this method and system. There are 9 levels plus an advanced “SAT” level (Level 10) with 6000 words. Levels 1—3 are for beginning readers and the remaining levels progress to level 10 for advanced readers.

Each student has their “ability” level, which is the level they should choose by determining how many words they can pronounce in a list associated with the level they initially try out. If they can pronounce 85% of the words in the list provided for that level, the student has found their correct level. Neuroscientifically, it is understood that some stress (“Good Challenge Stress”) is necessary to create new brain cells and new neural pathways in the brain. Being able to pronounce 85% (most) of the words, as opposed to all the words, creates “good challenge stress,” which optimizes reading development.

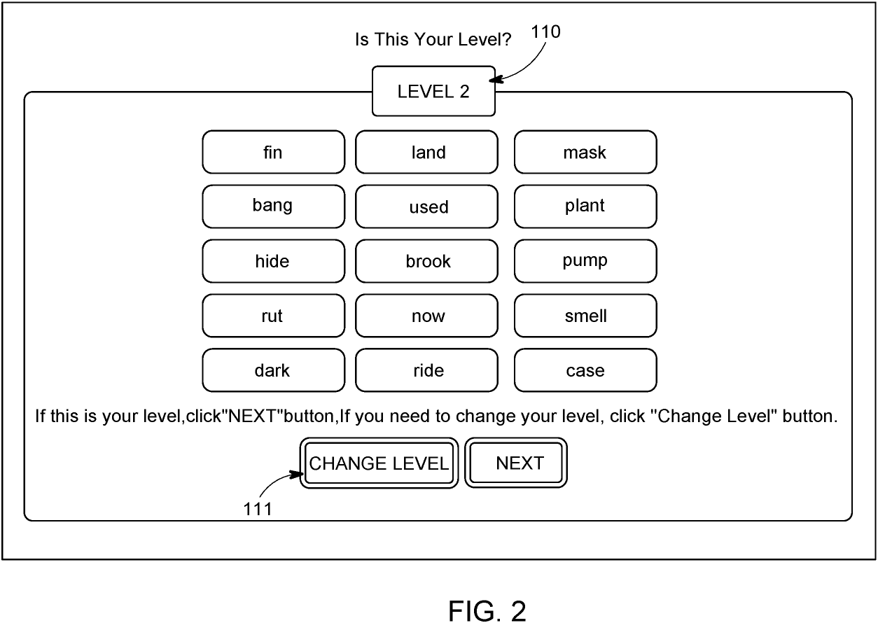

FIG. 2 shows a chosen level 110 selected for the training session. The chosen level 110, which becomes the level for the method and system, can be changed at any time and at any stage of the method and system through the always available “CHANGE LEVEL” button 111.

The disclosed neuroscientific reading training method and system comprises a plurality of words revealed incrementally-through a graphical encasement moving across a fully justified line (in this aspect in this Detailed Description section of this document, hereinafter referred to as “Paced Reading process”); and one word at a time tachistoscopically flashed within a non-moving graphical encasement (in this aspect in this Detailed Description portion of this document, hereinafter referred to as “Flash Words process”) used in combination create the optimized neural pathways for each student.

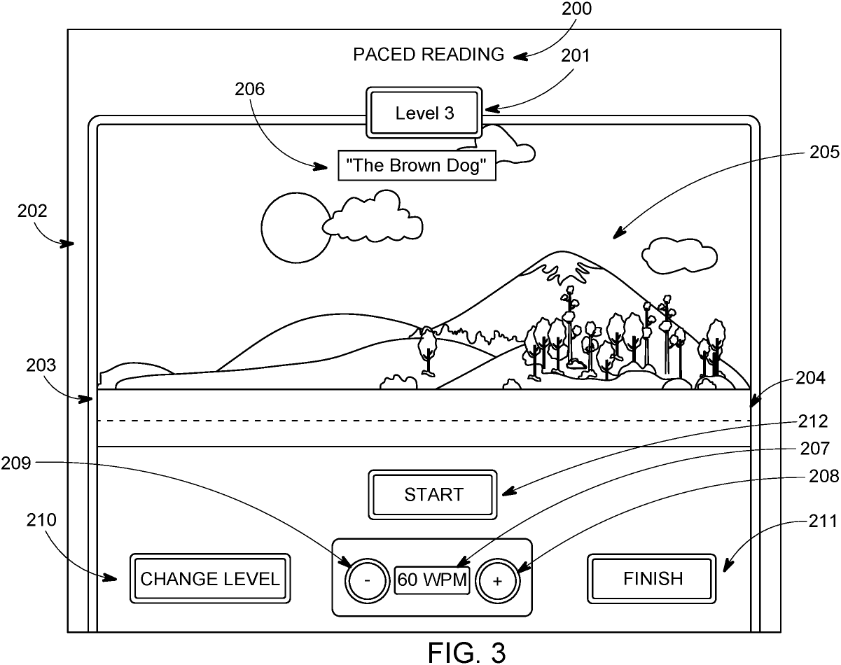

FIG. 3 introduces the Paced Reading process 200. The Paced Reading process 200 of the disclosed reading skills training method and system develops left to right “directionality” of a display in this aspect viewed by a student and the immediate return to the far left to begin the next line of words to be read with fully achieved, optimized directionality through a unique and exciting and manner of presenting words seen through moving “encasements” as an exemplary aspect. This process results in synthesized comprehension due to the synthesis of all 5 neuroscientific elements named herein of this method and system, which creates optimized fluency and speed for each student. The speed is decided upon through a “WPM” (words per minute) meter 207, (which should always be adjusted to the fastest speed that can be read by the student comfortably with understanding, by toggling “+” (208) or “-” (209) to raise or lower the WPM accordingly). Paced Reading increases each student’s “span of recognition” (unconsciously created and ideally one to two and a half words per “fixation,” which is a pause; poor readers can have only a small span of recognition-for example, seeing only a third of a word with 3 pauses/fixations for that word).

The Paced Reading process 200 shows a level indicator 201 incorporated into a display 202. The display 202 has a far left side 203 and a far right side 204. The display 202 includes a background 205 to frame the display. The background 205 may be a landscape scene, skyscape scene, cityscape, space background or other appealing backgrounds. The background 205 is the backdrop for display of title story words 206 as aspects of the training method. A Change Level button or icon 210 is also displayed, allowing the user to change the ability level at any time. A FINISH button 211 is also displayed for the user if they desire to end the Paced Reading training process. A Start button/icon 212 is displayed to allow the user to start the Paced Reading process 200. It is understood that aspects of the display and functionality presented in the figures with common reference numerals correspond with referenced elements in other figures with the same reference numerals.

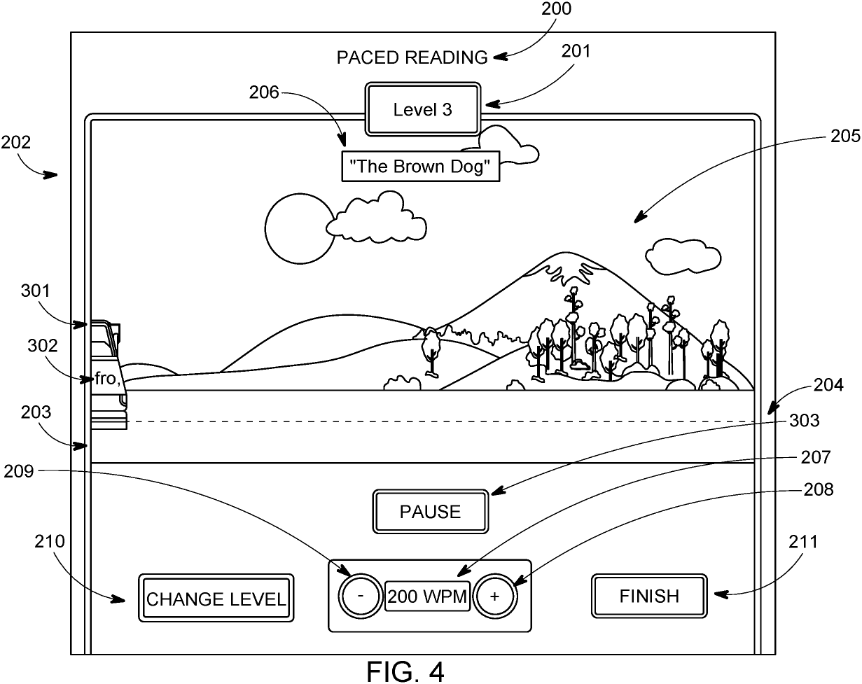

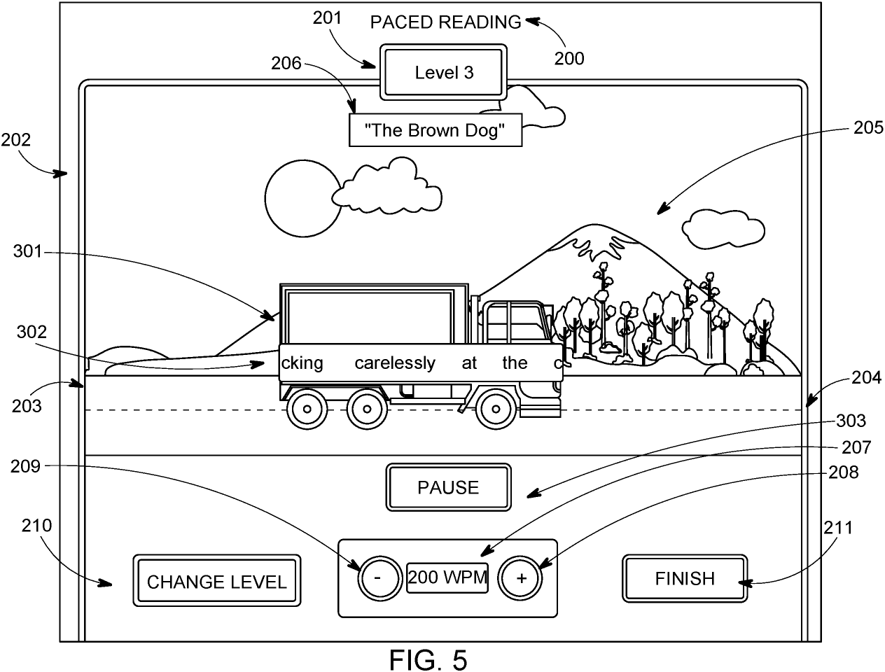

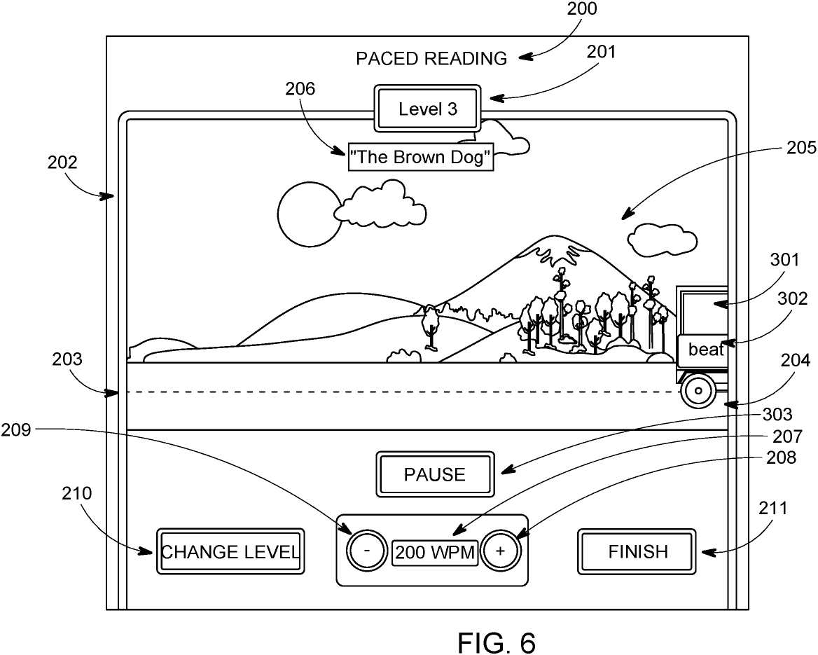

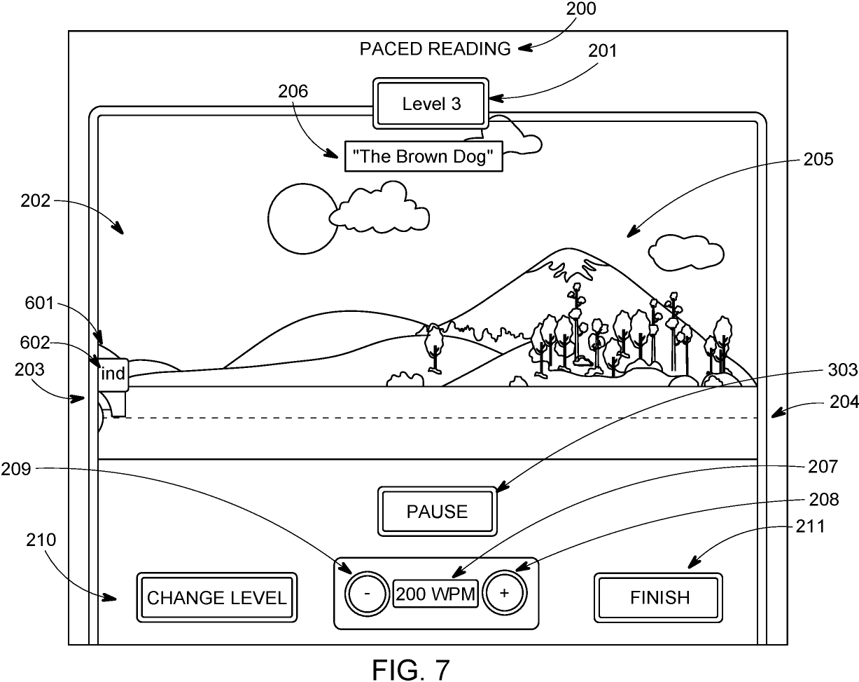

In the Paced Reading process 200 displayed in FIG. 4, multiple words are beginning to be revealed through a “see through” moving, fun, cool first moving graphical encasement 301 (a car, for example, given as one aspect herein, though other options exist, such as moving vehicles, avatars, superheroes, etc.) that will travels from the far left side 203 to the far right side 204 across a fully justified line 302, while the words seen in the moving graphical encasement 301 do not move like words in a book do not move. FIG. 5 shows the first moving graphical encasement 301 moving across the display 202. In FIG. 6, the first moving graphical encasement 301 drops off as the line of words 302 seen within its encasement 301 ends and disappears with the last letter of the last word. In FIG. 7, this disappearance is immediately followed by an audible sound followed by the appearance of the beginning a new and different second moving graphical encasement 601 at the far left 203, which begins a new line of words 602 to be seen through that moving new and different encasement 601, the second moving graphical encasement 601. These encasements 601 can be different models or colors of any chosen category of encasement “vehicle” 601 (though embodiments herein are cars, but can be avatars, animals, superheroes, trains, anything reasonable can be utilized). Also in this process, there will be both countryside and cityscapes as backgrounds 205 that do not move to accentuate the movement of the encasements and the resulting revealing of words to be read within. A PAUSE button 303 is also provided should the user need to pause the training session only to rest, not to see the words for an extended time frame.

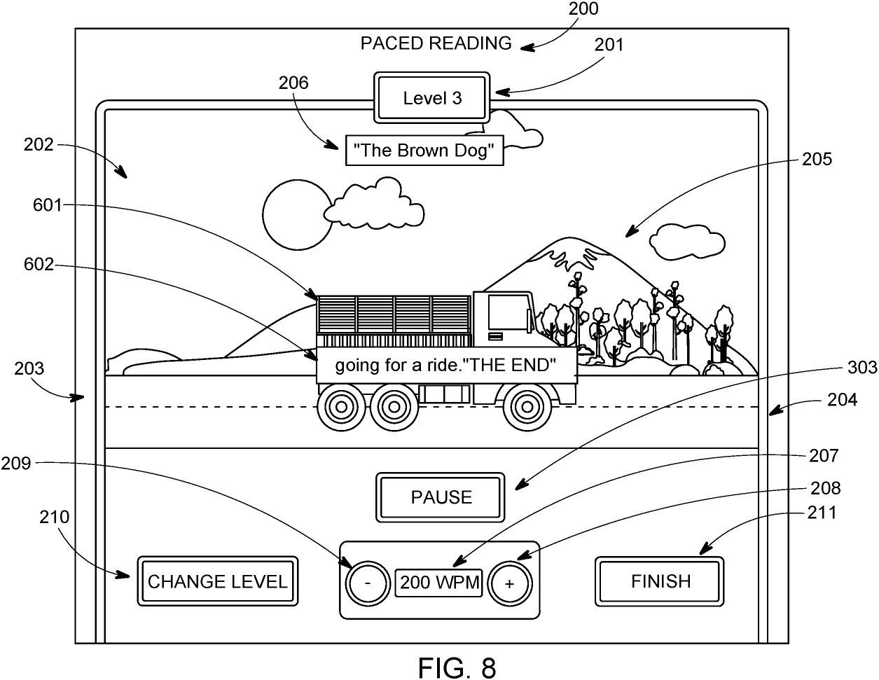

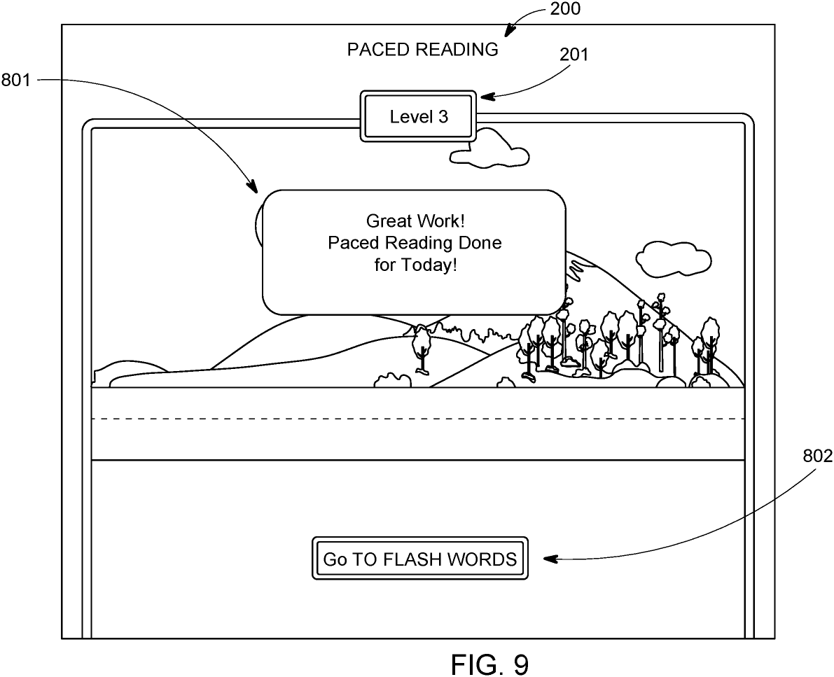

As the encasement 301 in FIG. 6 and the words 302 disappear at the end of the line at the far right 204 and drop off out of sight, there is a “beep” or other sharp audible sound that occurs, which immediately and additionally signals that the student has completed a line. This auditory beep sound in concert with the visual of the dropping off of the encasement that holds the last letter of the line creates a “dual modality” that enhances the visual intensity of each student’s experience and is known by neuroscientists as a form of “operant conditioning,” which in this case is a reward as well as a signal for completing the line. As shown in FIG. 8 when the full line of words 602 has been displayed and read, it states “The End” and in FIG. 9, a congratulatory message 801 (“Great Work!”) is displayed that also states (“Paced Reading Done for Today!”) The user then selects a flash words selection button 802 to move to the Flash Words process of the neuroscientific training of this aspect.

In this Paced Reading process of this aspect, all the words are to be read silently as opposed to orally, since students process information faster and more efficiently when reading silently, which is understood by neuroscientists, but not by teachers as a rule, or by the public at large. Further, neuroscientists understand that the brain processes complete words faster and more efficiently than phonetic pieces of words, which only complicates the reading training process, and all too often creates counterproductive neural pathways and their connections. Phonics has no productive place in the process of reading training, because with phonics, the brain has to take in additional and unnecessary didactic information.. Phonics and other language elements should only be introduced after the neuroscientific fundamentals are firmly put in place (the optimal neural pathways are created for reading skills and then reinforced through repetition). At that point, all other elements of English language information can be introduced and didactically taught on top of the critical neuroscientifically trained fundamentals.

After the process begins and the moving encasement 301 reveals words 302, the student or parent/teacher on the student’s behalf can then adjust the words per minute (WPM) meter 207 to the fastest speed that they can read SILENTLY with comfort and understanding. The WPM may be selected up/+ 208 or down/- 209. With this method and system, reading speed can become many multiples of speed for the students’ reading as they progress in this aspect of the disclosure.

After the “START” button 212 has been clicked, a “PAUSE” button 303 will appear in its place, as shown in FIG. 4, to be used only for a student to rest, not for a student to view the words longer than the method and system allows. To resume, click the “START” button 212 again. Also, when the story is finished, it will say “THE END” and the student will choose whether to repeat the same story again by clicking “START” button 212 or click “FINISH” button 211 to end this process for the day.

The student can change their level at any time with the “CHANGE LEVEL” button 210, and the student can also change the speed through the WPM meter 207 at any time as well.

In an aspect of the neuroscientific method, the student should repeat a “story” several times for a period of 10-15 minutes for 5 days per week. Again, when Paced Reading is completed for the day, the student should click “FINISH” button 211. In an aspect, a “GO TO FLASH WORDS” button 802 is displayed to allow the user to move to the Flash Words process of the training.

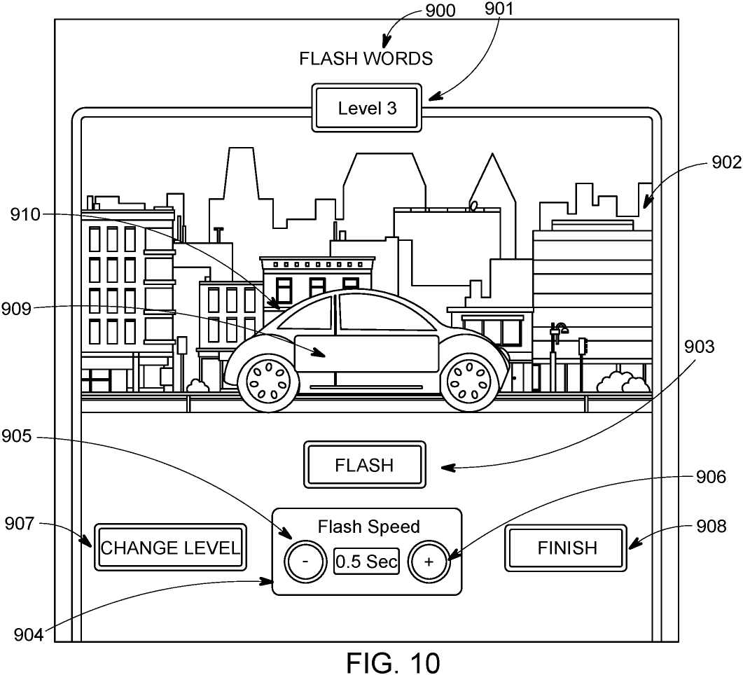

FIG. 10 shows an example screen of the Flash Words process 900. In an aspect of the training method, the Flash Words process 900 of the disclosed unique neuroscientific reading training method and system is designed to create an optimized increase of memory, both from short term as well as short term to long term with each repetition, speed of memory recovery as well as an increase to each student’s optimal levels of spelling, vocabulary, pronunciation, span of recognition, focus, concentration, operant conditioning, and visualization capabilities.

In the Flash Words process 900 (a “tachistoscopic” neuroscientific action), only one word at a time will be revealed in a display in its own stationary, cool, fun graphical encasement 910 - different in category or in the same category but with different styles or colors as compared to the Paced Reading process per day - is shown to the student one word at a time, as compared to multiple words, that are revealed in sequence in its cool, fun encasement as it moves from the far left to the far right in the Paced Reading process. As a result of this design in this aspect, having each word flashed in its own encasement, each word is differentiated and becomes unique and special to the student.

In an aspect of the training method and system, after the student clicks the “FLASH” button 903 presented on the display, there is a delay, preferably a one second delay before the word is flashed, which adds anticipation and its associated challenge stress; it also adds focus and concentration, while reinforcing central vision.

When a word is flashed, it is seen by the student for only a fraction of a second, and they are told so (i.e., added challenge stress), though the speed of the flash can be customized to meet each student’s capability, always reaching for the fastest speed possible with the student’s progression.

The Flash Word process sequence flow is described below.

In an aspect, and in accordance with the student’s chosen level, there will be a list of appropriate words to be flashed one at a time.

To begin the Flash Words process 900, the student will click or select the “FLASH” button 903 displayed before the student. After the student clicks or selects the “FLASH” button 903, there is a delay, preferably a one second delay before the word 909 is flashed tachistoscopically for the student.

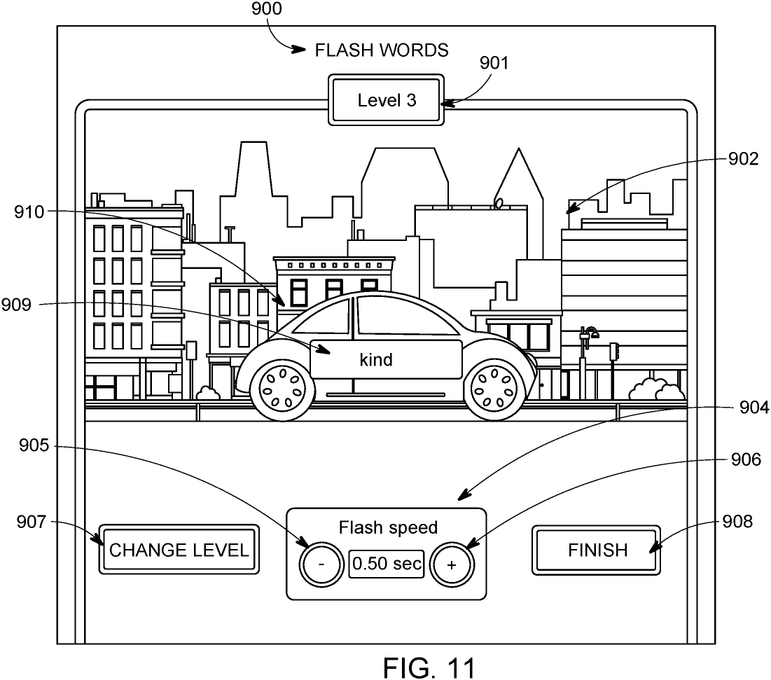

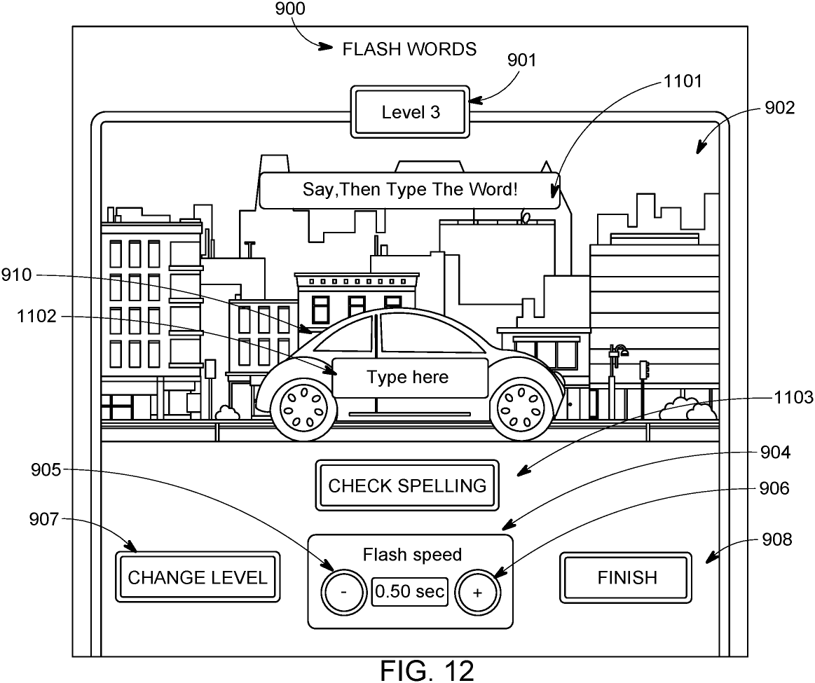

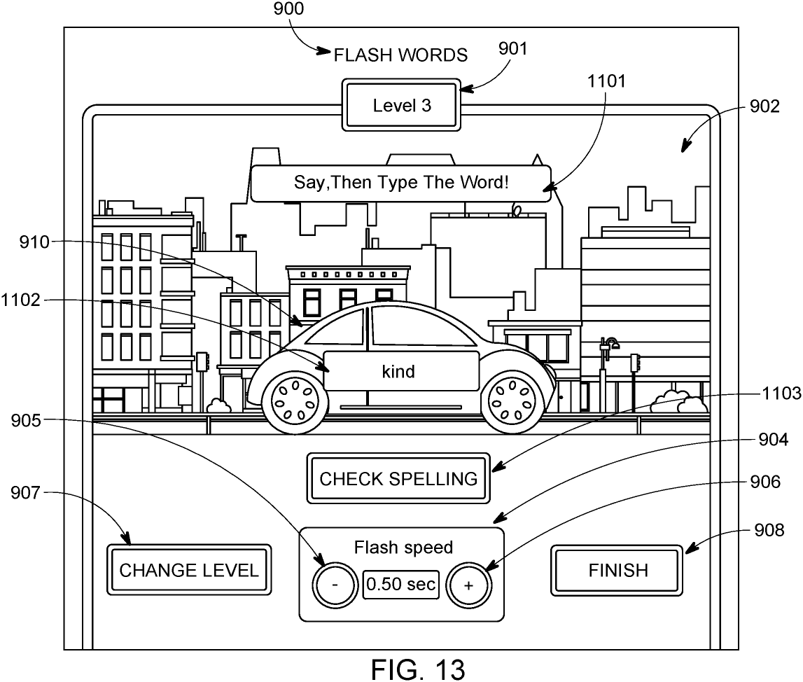

As shown in FIG. 11, a word 909 is flashed (here, “kind”) and uniquely simultaneously pronounced correctly by an audio produced voice. As shown in FIG. 12, the student is prompted with an icon 1101 to “Say, Then Type The Word” in the designated open space 1102 now on the screen where the flashed word 909 was shown and correctly pronounced. A shown in FIG. 13, the student then immediately says the word 909 as they heard it, and then types in the word 1102 as they saw it and remember it. The student then clicks or selects the “CHECK SPELLING” button 1103, which will be utilized when the word comes in and is typed into the input area. In that fraction of a second, the word is correctly pronounced by an audio-produced voice prompted to be heard simultaneously with the flashing of the word (the function of dual/multiple modalities), which, in this case, uniquely enhances the visual aspect of this activity powerfully.

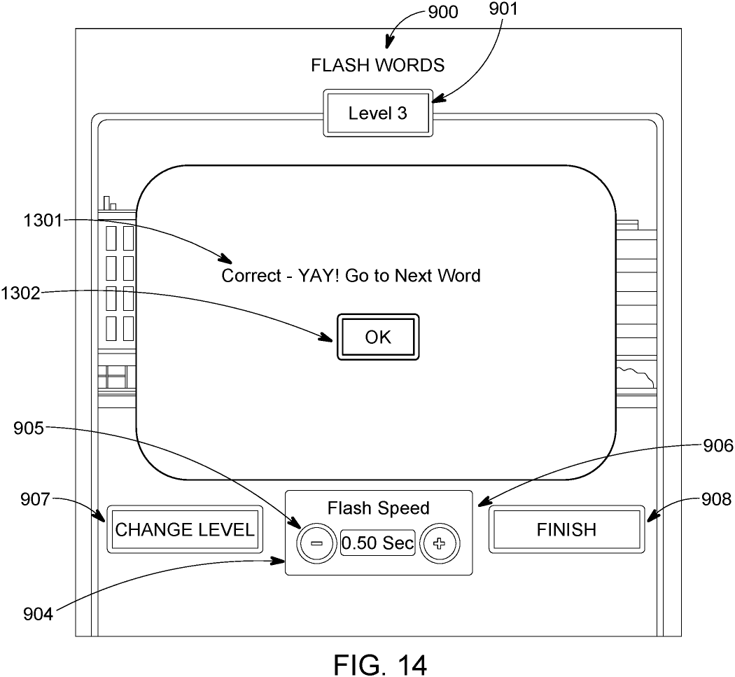

In an aspect, with a correct response as shown in FIG. 14, there will be “POP-UP” addressing the student’s spelling that will either indicate “CORRECT-YAY! Go to Next Word!” icon 1301 (or other encouraging message) with an “OK” button 1302.

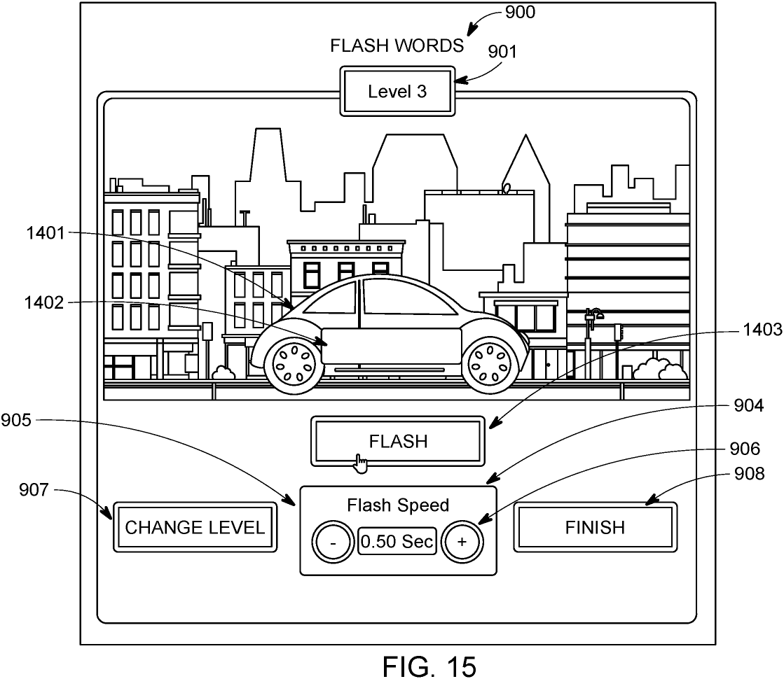

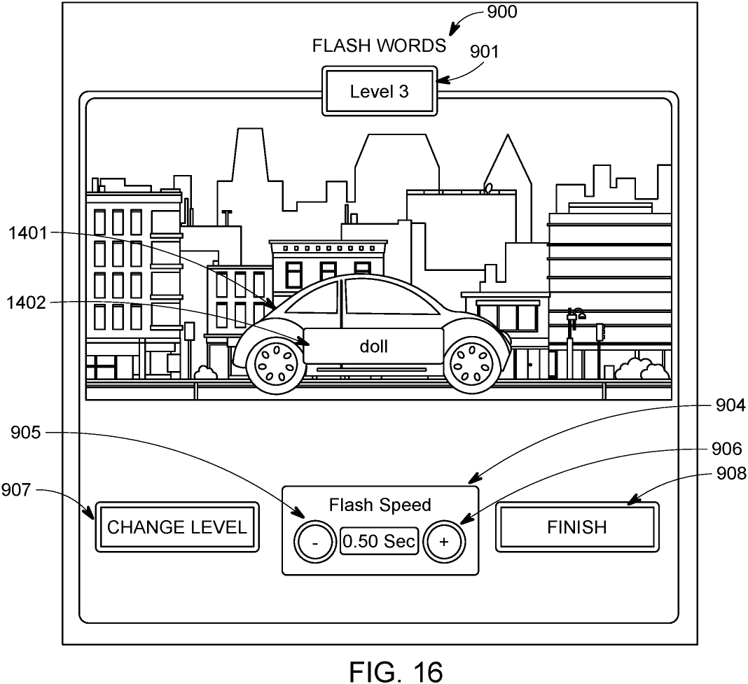

In FIG. 15, if the student is CORRECT for the prior flashed word, a new word 1402 is introduced in a new, second graphical encasement 1401 with the click or selection of the OK button 1302 in FIG. 14 and then the FLASH button 1403. The student will then see the screen shown as an example aspect in FIG. 16, with the new, second graphical encasement 1401 and a new word 1402 (here, “doll”) and “FLASH” prompt 1403.

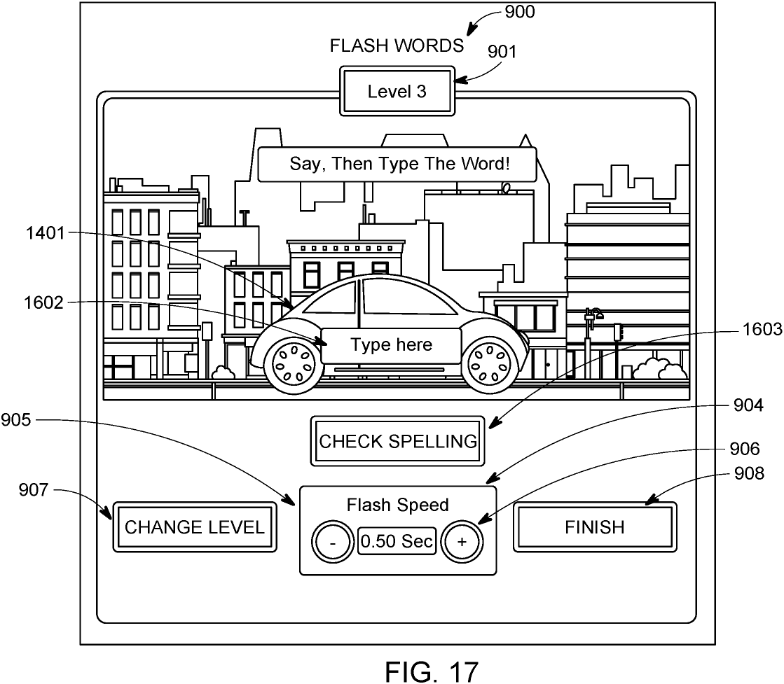

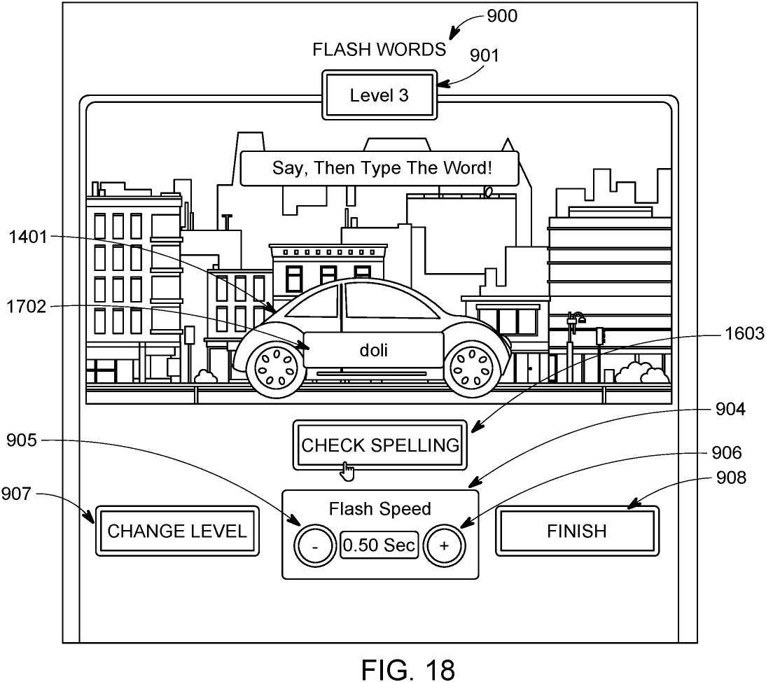

As shown in FIG. 17, the student is prompted with an icon 1601 to “Say, Then Type The Word” in the designated open space 1602 now on the screen where the flashed word 1402 (“doll”) was shown and correctly pronounced. As shown in FIG. 18, the student then immediately says the word 1402 as they heard it, and then types in the word 1702 as they saw it and remember it. Here, in an example aspect, the student incorrectly types in “doli.” The student then clicks or selects the “CHECK SPELLING” button 1603, which is used when the word comes in and is typed into the input area. In that fraction of a second, the word is correctly pronounced by an audio-produced voice prompted to be heard simultaneously with the flashing of the word (the function of dual/multiple modalities), which, in this case, uniquely enhances the visual aspect of this activity powerfully.

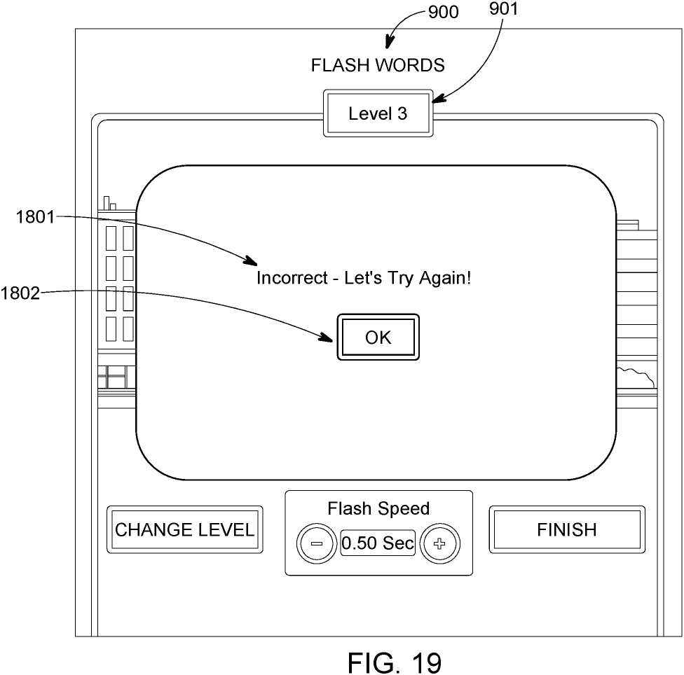

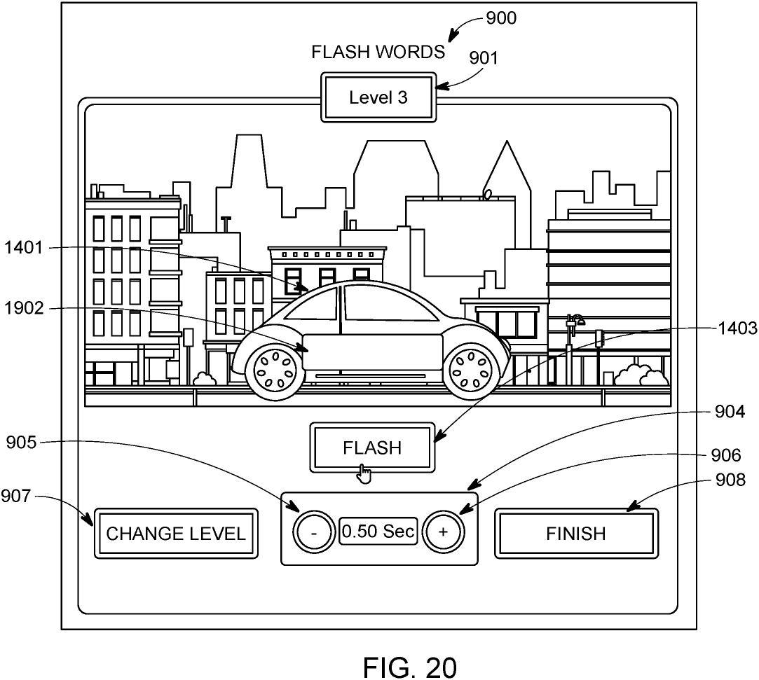

In an aspect, if the input word is INCORRECT as shown in FIG. 19 (“Incorrect -Let’s Try Again!”) in message box 1801, the OK button 1802 is clicked and, as shown in FIG. 20, followed by the FLASH button 1403 to flash the same word 1402 again, in the display area 1902 using the same graphical encasement 1401.

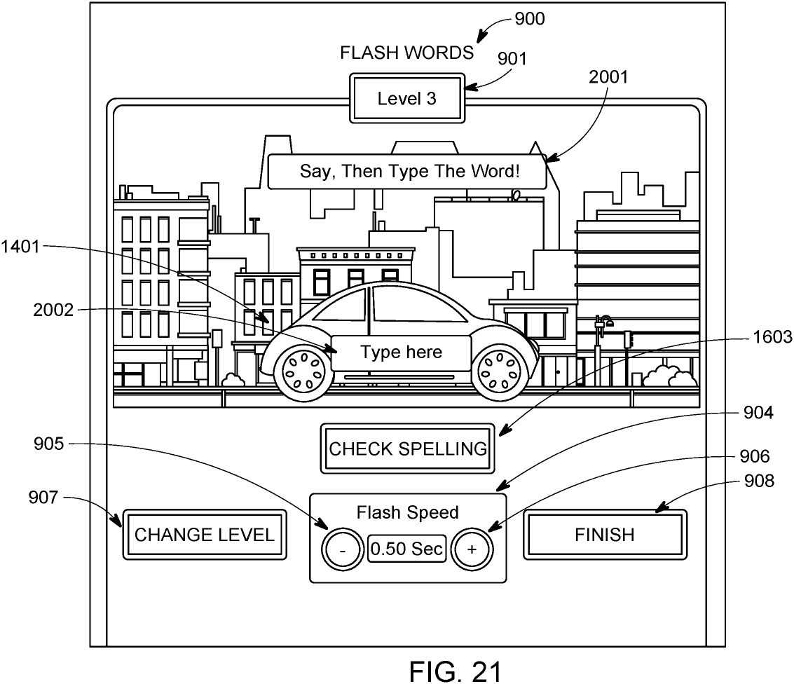

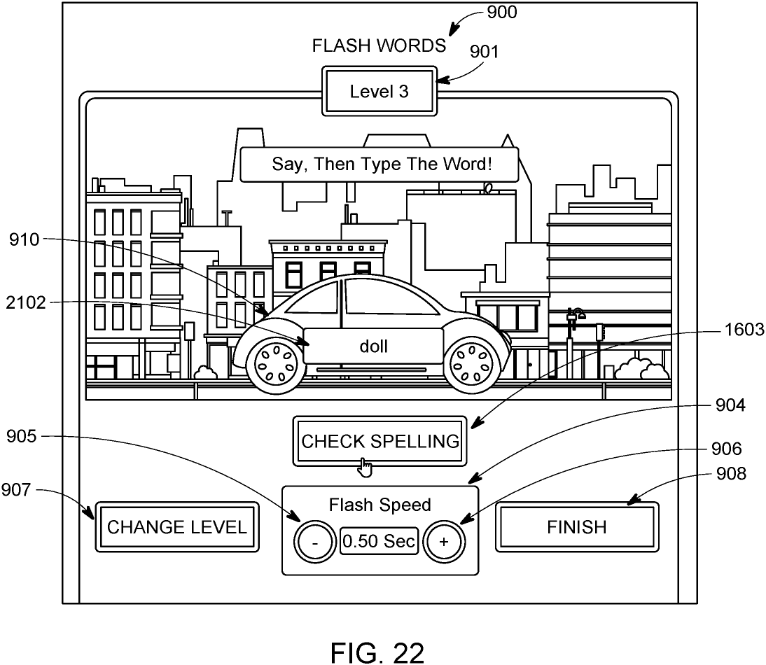

As shown in FIG. 21, the student is prompted with an icon 2001 to “Say, Then Type The Word” in the designated open space 2002 now on the screen where the flashed word 1402 was shown. As shown in FIG. 22, the student then immediately says the word 909 as they heard it, and then types in the word 1402 as they saw it and remember it. The student then clicks or selects the “CHECK SPELLING” button 1603. In that fraction of a second, the word is correctly pronounced by an audio-produced voice prompted to be heard simultaneously with the flashing of the word (the function of dual/multiple modalities), which, in this case, uniquely enhances the visual aspect of this activity powerfully.

It is noted that FIG. 21 does not present acts of flashing of the same word, then “Say, Then Type The Word” and then the “Check Spelling” as shown in FIGS. 16-18 above, so as to omit the repetitious figures involved in the disclosed method and system. In an aspect of the disclosure, the same word will be FLASHED again, because the word entered was INCORRECT, to allow the student two more attempts with the same word. Then FIG. 21 would be displayed. It is understood that other numbers of allowed attempts may be used as part of the disclosed system and method.

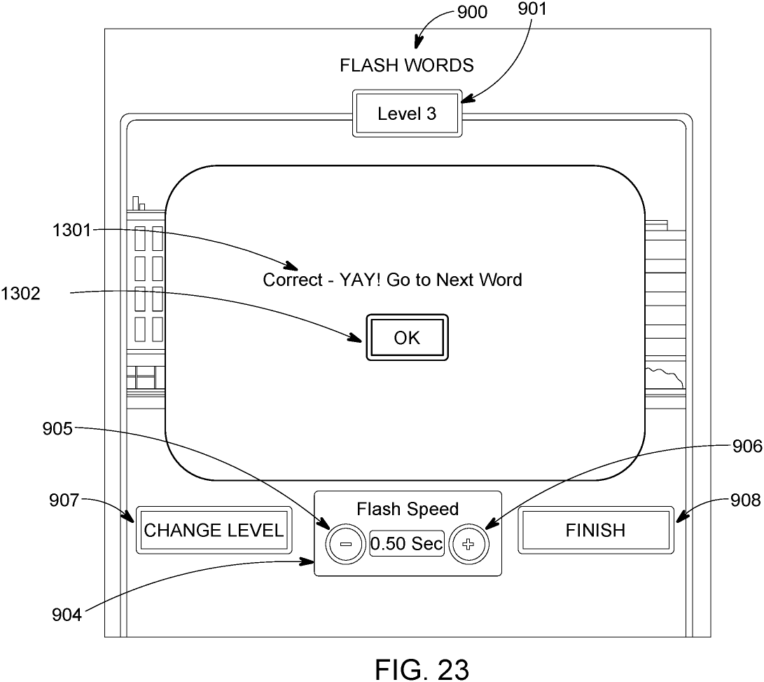

If the student correctly typed the word 1402 and correctly pronounced it, the student is presented with the display shown in FIG. 23. In an aspect, with a correct response as shown in FIG. 23, there will be “POP-UP” addressing the student’s spelling that will either indicate “CORRECT-YAY! Go to Next Word!” icon 1301 (or other encouraging message) with an “OK” button 1302.

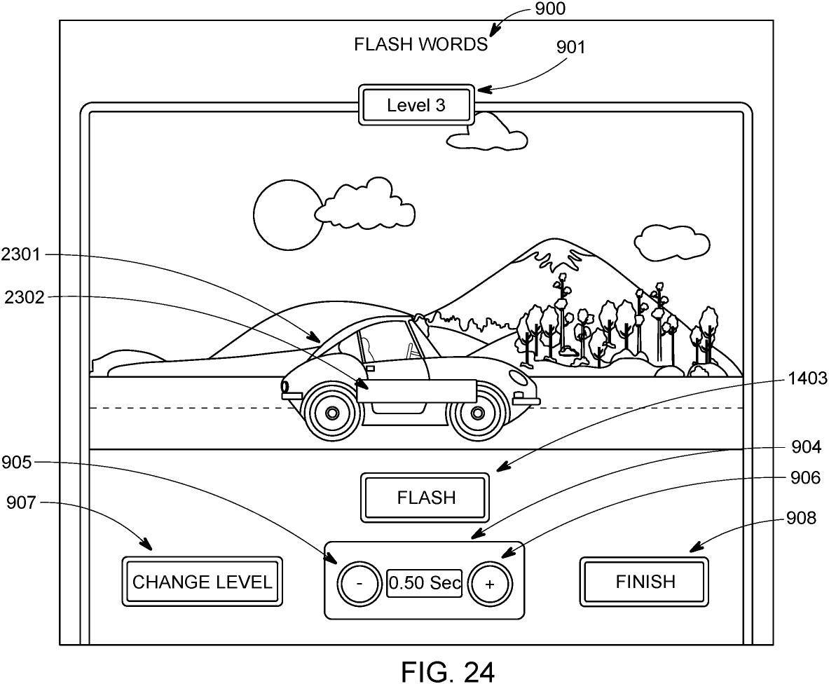

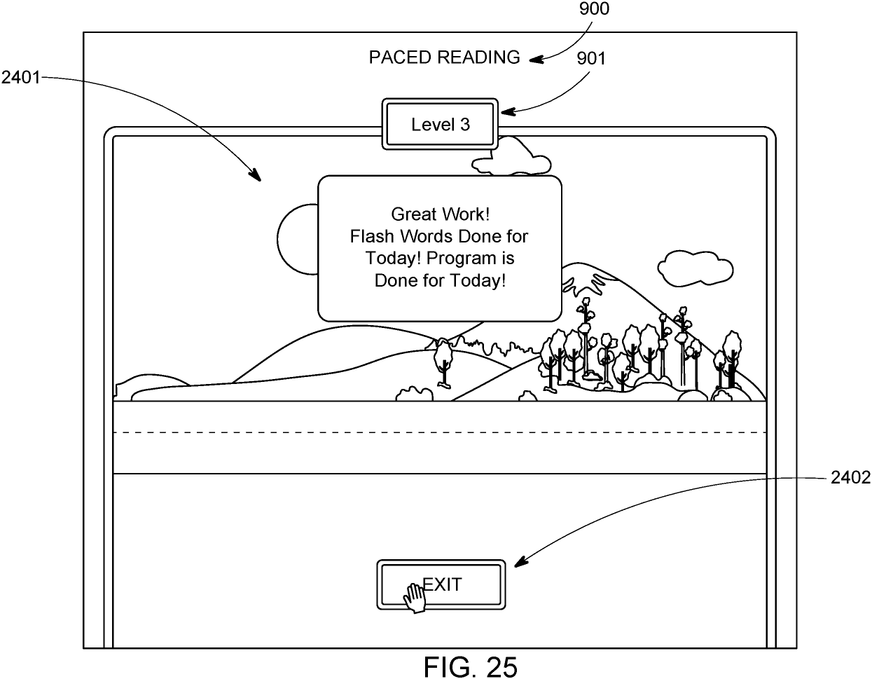

FIG. 24 shows an example display of a new graphical encasement within which the tachistoscopic flashing of a new word-will be displayed after the “Correct - YAY! Go to Next Word!” is displayed in FIG. 23, but instead of flashing a new, different word, the choice is made to FINISH this part of the training, and in fact the whole day’s training program, as indicated in the next FIG. 25, according to an aspect of the disclosure. In FIG. 24, if the student is CORRECT for the prior flashed word, a new word 2302 is introduced in a new, second graphical encasement 2301 with the click or selection of the OK button 1302 in FIG. 23 and then the FLASH button 1403.

In an aspect, if the student is INCORRECT three times, a new word from their designated list is introduced.

When the student has been working on FLASH WORDS for 10-15 minutes, as an example aspect, the student may click the “FINISH” button 908 in FIG. 24. FIG. 25 shows an example display when the Flash Words process is completed for the day, according to an aspect of the disclosure. The student will be presented with a “POP UP” 2401 with a message such as “Great Work! Flash Words Done for Today! Program is Done for Today!” Other messages may be substituted to indicate completion of the program for the day. The student may then select “EXIT” in input area 2402. In an aspect, the student should repeat the words that were flashed several times for a period of 10-15 minutes for 5 days per week.

In an aspect, the student can change their level at any time with the “CHANGE LEVEL” button, and the student can also change the speed through the “SPEED” meter at any time as well. The speed should be adjusted to the fastest speed that can be accomplished comfortably by the student.

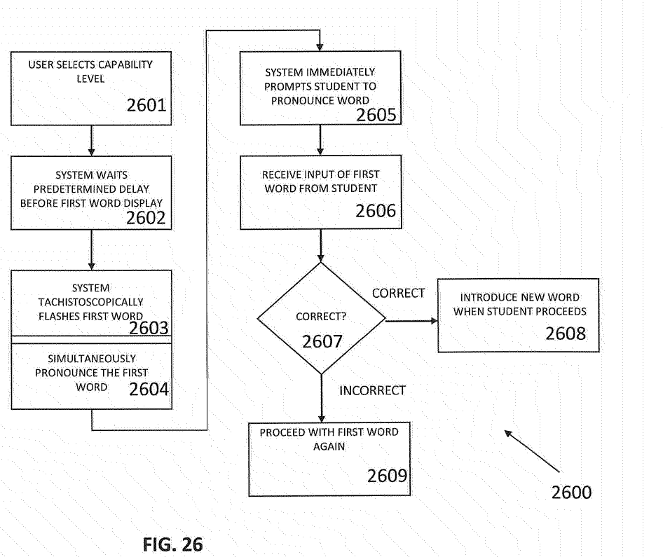

FIG. 26 illustrates a flowchart 2500 for acts taken in an exemplary neuroscientific method to train optimized reading skills proficiency customized to the needs of each participating student causing a creation of optimized neural pathways and reinforcement of the optimized neural pathways through repetition of the neuroscientific method using Paced Reading as a process. FIG. 26 is explained in conjunction with FIG. 1 to FIG. 25. A first training engine may be utilized to implement the process described in FIG. 26. The control starts at act 2501.

At act 2501, a user (e.g., a student, a teacher/parent) selects a capability level customized for each participating student for either a part or all of a Paced Reading training process or at any time during an entire training.

At act 2502, the user or other participant selects a word speed customized for each student, where the word speed is decided upon by a words per minute (WPM) meter, where the word speed modifiable during the Paced Reading training process or at any time during an entire training.

At act 2503, the system presents on a display a plurality of words revealed incrementally through a first moving graphical encasement that proceeds from a far left side of the display to a far right side of the display. The plurality of words includes a fully justified line of words to be utilized for training by each student. The first moving graphical encasement reveals a beginning portion of the plurality of words as and through the first moving graphical encasement proceeds across the display. In an aspect, the first moving graphical encasement and the second different moving graphical encasement comprise an icon of a moving vehicle, mobile entity or avatar or other appealing movable object. In an aspect, the system may display a static background behind the first moving graphical encasement and the second different moving graphical encasement, such as geographic scenery, landscapes, cityscapes, outer space backgrounds or other appealing background imagery to present during the training.

At act 2504, the system automatically removes the first moving graphical encasement from the far right side of the display when the plurality of words seen within the first moving graphical encasement ends. As the first moving graphical encasement reaches the far right side of the display, the first moving graphical encasement is automatically removed off the display, to depict vanishing off the display.

At act 2505, the system, upon removing the first moving graphical encasement from the display, immediately and automatically issues an audible sound to indicate that the full line of words has been completed. In an aspect, the audible sound may be a sharp beep or other indicating sounds that are noticeable but preferably not jarring or disturbing. The audible sound given at the same time as the visual ending of the encasement and the last letter within that encasement dropping off creates enhanced visual intensity due to this uniquely utilized dual modality of this aspect of the training method and system.

At act 2506, the system immediately and automatically presents thereafter on the display a second moving graphical encasement, different from the first moving graphical encasement to indicate a new line of words has begun and seen through the second different moving graphical encasement. The second moving graphical encasement appears on the far left side of the display and proceeds to the far right side of the display, where the indicated five neuroscientific elements of the training system and method results in synthesized comprehension for each student and creates an optimized fluency for each student.

FIG. 27 illustrates a flowchart 2600 for acts taken in an exemplary neuroscientific method to train optimized reading skills proficiency customized to needs of each participating student causing the creation of optimized neural pathways and reinforcement of the optimized neural pathways through a repetition of the neuroscientific method using a tachistoscopic flash word as a process. A second training engine may be utilized to implement the process described in FIG. 27. Control begins at act 2601.

At act 2601, a user (e.g., a student, parent/teacher selects a capability level customized for each participating student for either a part or all of a Flash Word training session or at any time during an entire training.

At act 2602, the system waits a predetermined delay before a first word is to be flashed. In an aspect, the predetermined delay may be a one second delay.

At act 2603, the system tachistoscopically flashes the first word, where the first word is displayed in a graphical encasement around the first word, where the tachistoscopic flashing of the first word results in an optimized increase of short term memory and long term memory, a speed of memory recovery, an increase to the student’s optimal levels of spelling, vocabulary, pronunciation, span of recognition, focus, concentration, operant conditioning and visualization capabilities.

At act 2604, the system simultaneously with tachistoscopically flashing the first word, pronounces the first word by an audio-produced voice.

At act 2605, the system immediately prompts the student to pronounce the first word as just heard by the audio-produced voice simultaneously with a visual of the tachistoscopically flashing of the word to note a spelling of the first word, and to then input the first word into a designated region of the display where the first word was flashed.

At act 2606, the system receives from the student an input of the first word from the designated region of the display.

At act 2607, the system determines if the input is correct.

At act 2608, the system, responsive to the input of the first word being correct, displays an encouragement message on the display and displaying an icon for the student to select to proceed, where upon selecting the icon to proceed, introducing a second word displayed within a second different graphical encasement and displaying the flash icon to proceed to providing the flash.

At act 2609, the system, responsive to the input of the first word being incorrect, displays an encouragement message (“Incorrect - Let’s Try Again!”) on the display and displays an icon for the student to select to proceed. Upon selecting the icon to proceed, the system displays the flash icon to proceed with the first word displayed again and within the same first graphical encasement. If the first word is incorrectly input into the designated region of the display three times in a row, the system introduces the second word.

Blocks of the flowchart 2500 and 2600 support combinations of means for performing the specified functions and combinations of operations for performing the specified functions of an aspect. It will also be understood that one or more blocks of the flowcharts 2500 and 2600, and combinations of blocks in the flowcharts 2500 and 2600, can be implemented by special purpose hardware-based computer systems which perform the specified functions, or combinations of special purpose hardware and computer instructions. Also, more, fewer or different steps may be provided. Any of these modifications do not deviate from the scope of the disclosure and the novel inventive features presented herein.

Alternatively, the system may comprise other means for performing each of the operations described above. In this regard, according to an example aspect, examples of means for performing operations may comprise, for example, a computer processor and/or a device or circuit for executing instructions or executing an algorithm for processing information as described above. In an aspect, the disclosure may be implemented in a computer system with processors configured to execute instructions for the acts in FIG. 26 and FIG. 27, separately or with the Paced Reading and Flash Words processes combined. A Paced Reading engine may be configured to provide instruction for the Paced Reading process. A Flash Words engine may be configured to provide instruction for the Flash Words process. Storage in the form of databases located in local, remote or cloud storage locations may be used in conjunction with the disclosed system and method for words, word levels, graphics, audio-visual interaction and other types of data or information that may be used with the disclosed system and method. Computer I/O devices may also be used, such a mouse, stylus, touch pads, touch screens, keyboards, speakers, microphones, headsets or other I/O devices known to one of skill in the art to be used with the disclosed system and method.

It will be understood that each block of the flowcharts and combination of blocks in the flowcharts may be implemented by various means, such as hardware, firmware, processor, circuitry, and/or other communication devices associated with execution of software including one or more computer method and system instructions. For example, one or more of the procedures described above may be embodied by computer method and system instructions. In this regard, the computer method and system instructions which embody the procedures described above may be stored by a memory device of an apparatus employing an aspect of the present disclosure and executed by the processing circuitry. As will be appreciated, any such computer method and system instructions may be loaded onto a computer or other programmable apparatus (for example, hardware) to produce a machine, such that the resulting computer or other programmable apparatus implements the functions specified in the flowchart blocks. These computer method and system instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer method and system instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

A “computer-readable medium,” “machine-readable medium,” “propagated-signal” medium, and/or “signal-bearing medium” may comprise any means that contains, stores, communicates, propagates, or transports software for use by or in connection with an instruction executable system, apparatus, or device. The machine-readable medium may selectively be, but not limited to, an electronic, magnetic, optical, electromagnetic, infrared, or semiconductor system, apparatus, device, or propagation medium. A non-exhaustive list of examples of a machine-readable medium would include: an electrical connection “electronic” having one or more wires, a portable magnetic or optical disk, a volatile memory such as a Random Access Memory “RAM” (electronic), a Read-Only Memory “ROM” (electronic), an Erasable Programmable Read-Only Memory (EPROM or Flash memory) (electronic), or an optical fiber (optical). A machine-readable medium may also include a tangible medium upon which software is printed, as the software may be electronically stored as an image or in another format (e.g., through an optical scan), then compiled, and/or interpreted or otherwise processed. The processed medium may then be stored in a computer and/or machine memory.

Many modifications and other aspects of the disclosures set forth herein will come to mind to one skilled in the art to which these disclosures pertain having the benefit of the teachings presented in the foregoing descriptions and the associated drawings. Therefore, it is to be understood that the disclosures are not to be limited to the specific aspects disclosed and that modifications and other aspects are intended to be included within the scope of the appended claims. Furthermore, in some aspects, additional optional operations may be included. Modifications, additions, or amplifications to the operations above may be performed in any order and in any combination.

Moreover, although the foregoing descriptions and the associated drawings describe example aspects in the context of certain example combinations of elements and/or functions, it should be appreciated that different combinations of elements and/or functions may be provided by alternative aspects without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A neuroscientific method to train optimized reading skills proficiency customized to
needs of each participating student using a plurality of words revealed incrementally through a first moving graphical encasement across a first fully justified line and immediately then a second moving graphical encasement across a second fully justified line causing a creation of specific to task optimized neural pathways and reinforcement of these optimized neural pathways through repetition of the neuroscientific method, the method comprising:
selecting a capability level customized for each participating student for either a part or all of a training with the plurality of words or at any time during an entire training;
selecting a word speed customized for each student, where the word speed is decided upon by a words per minute meter, where the word speed is modifiable during a plurality of words reading training session;
presenting on a display a plurality of words revealed incrementally through a first moving graphical encasement that proceeds from a far left side of the display to a far right side of the display, where the plurality of words comprises a fully justified line of words to be utilized for training each student, and where at the far left side the first moving graphical encasement is revealed and reveals letters of a first word seen is a beginning portion of the first plurality of words to proceed across the display to the end of the fully justified line at the far right of a display;
removing automatically the first moving graphical encasement from the far right side of the display when a last letter of the plurality of words seen within the first moving graphical encasement ends;
upon removing the first moving graphical encasement from the display, immediately and automatically issuing an audible sound to indicate that the full line of words has been completed, which is neuroscientifically known as a positive form of operant conditioning in a case at a particular time; and
presenting immediately and automatically thereafter on the display a second moving graphical encasement, different from the first moving graphical encasement to indicate a new line of words has begun and seen through the second moving graphical encasement, the second moving graphical encasement appearing on the far left side of the display and proceeding to the far right side of the display, where the neuroscientific method results in a major part of synthesized comprehension for each student, a reduction or elimination of regressions, an increased span of recognition with the associated number of fixations, creating optimized directionality, and resulting in creating an optimized fluency for each student.

2. The neuroscientific method of claim 1, where the first moving graphical encasement and the second moving graphical encasement comprise an icon of a moving vehicle, mobile entity or avatar, where the second moving graphical encasement is different in color and/or form from the first moving graphical encasement.

3. The neuroscientific method of claim 1, further comprising displaying a static background behind the first moving graphical encasement and the second moving graphical encasement.

4. A neuroscientific method to train optimized reading skills proficiency customized to the needs of each participating student using tachistoscopic flashing of words shown to each participating student for a predetermined period of time, causing the creation of specific to task-optimized neural pathways and reinforcement of the optimized neural pathways through a repetition of the neuroscientific method, the method comprising:
selecting a capability level customized for each participating student for either a part or all of the tachistoscopic training or at any time during an entire training;
waiting a predetermined delay before a first word is to be flashed, which causes anticipation, excitement, intensity of focus, and intensity of central vision;
tachistoscopically flashing the first word, where the first word is displayed in a graphical encasement around the first word, where the tachistoscopic flashing of the first word results in an optimized increase of short-term memory and long-term memory, a speed of memory recovery, an increase to the student’s optimal levels of spelling, vocabulary, pronunciation, span of recognition, focus, concentration, operant conditioning and visualization capabilities;
simultaneously with tachistoscopically flashing the first word, pronouncing the first word by an audio-produced voice, thereby utilizing dual modalities, which enhances a visual aspect;
immediately prompting the student to pronounce the first word as just heard by the audio-produced voice simultaneously with a visual of the tachistoscopically flashing of the word to note a spelling of the first word, and to then input the first word into a designated region of the display where the first word was flashed;
receiving from the student an input of the first word from the designated region of the display;
responsive to the input of the first word being correct, displaying a first encouragement message on the display;
responsive to the input of the first word being incorrect, displaying a second encouragement message on the display.

5. The neuroscientific method of claim 4, where the predetermined delay comprises a one second delay.

6. A neuroscientific system to train optimized reading skills proficiency customized to needs of each participating student using a plurality of words revealed incrementally as well as using a tachistoscopic flashing of words, which causes a creation of optimized specified to task optimized neural pathways and reinforcement of the optimized neural pathways through a repetition of use of the neuroscientific system, the system comprising:
at least one memory configured to store computer executable instructions;
at least one processor configured to execute the computer executable instructions;
a first training engine comprising first computer executable instructions for:
selecting a capability level customized for each participating student for either part or all of a training session or at any time during an entire training;
selecting a word speed customized for each student, where the word speed is decided upon by a words per minute meter, where the word speed is modifiable during any part of an entire use of a plurality of words;
presenting on a display a plurality of words revealed incrementally through a first moving graphical encasement that proceeds from a far left side of the display to a far right side of the display, where the plurality of words comprises a full justified line of words to be utilized for training by each student, and where the first moving graphical encasement reveals a beginning portion of the plurality of words as the first moving graphical encasement proceeds across the display;
removing automatically the first moving graphical encasement from the far right side of the display when the plurality of words seen within the first moving graphical encasement ends;
upon removing the first moving graphical encasement from the display, immediately and automatically issuing an audible sound to indicate that the full line of words has been completed; and
presenting immediately and automatically thereafter on the display a second moving graphical encasement, different from the first moving graphical encasement to indicate a new line of words has begun and seen through the second moving encasement, the second moving graphical encasement appearing on the far left side of the display and proceeding to the far right side of the display, where the neuroscientific method results in a major part of synthesized comprehension for each student and creates an optimized fluency for each student.
a tachistoscopic second training engine comprising second computer executable instructions for:
selecting a capability level customized for each participating student;
providing a flash icon on a display for the student to select;
waiting a predetermined delay before a first word is to be flashed;
tachistoscopically flashing the first word, where the first word is displayed in a graphical encasement around the first word, where the tachistoscopic flashing of the first word creates an optimized increase of short term memory and long term memory, a speed of memory recovery, an increase to the student’s optimal levels of spelling, vocabulary, pronunciation, span of recognition, focus, concentration, operant conditioning and visualization capabilities;
simultaneously with tachistoscopically flashing the first word, a dual modality of audio and visual elements is produced simultaneously pronouncing the first word by an audio-produced voice at a same moment the word is flashed; and
immediately prompting the student to pronounce the first word as just heard by the audio-produced voice simultaneously with a visual of the flashing of the first word to note a spelling of the first word, and to then input the first word into a designated region of the display where the first word was flashed.

7. The neuroscientific system of claim 6, where waiting a predetermined delay comprises waiting one second.

8. The neuroscientific system of claim 6, where the first moving graphical encasement and the second moving graphical encasement comprise an icon of a moving vehicle, mobile entity or avatar, where the second moving graphical encasement is different in color and/or form from the first moving graphical encasement.

9. The neuroscientific system of claim 6, further comprising displaying a static background behind the first moving graphical encasement and the second moving graphical encasement.

10. The neuroscientific system of claim 6, where the first training engine and the second training engine execute for a duration of 10-15 minutes.
